(19) United States
(12) Patent Application Publication
(10) Pub. No.: US 2026/0274583 A1
(43) Pub. Date: Sep. 17, 2026

(54) FLIGHTED BELT CONVEYOR AND SCRAPER

(71) Applicant: Laitram, L.L.C., Harahan, LA (US)

(72) Inventors: Gurvinder Gandhi, Metairie, LA (US); Bryant G. Ragan, Metairie, LA (US); Jake A. Mohan, Grand Rapids, MI (US)

(21) Appl. No.: 19/545,767

(22) Filed: Feb. 20, 2026

Related U.S. Application Data
(60) Provisional application No. 63/772,998, filed on Mar. 17, 2025.

(51) Int. Cl. B65G 45/14; B65G 15/44

(52) U.S. Cl. CPC B65G 45/14; B65G 15/44; B65G 2203/0266; B65G 2203/042; B65G 2207/40

(57) ABSTRACT

Conveyor systems with scraper assemblies to scrape bulk products and residue adhering to the outer conveying surfaces and the faces of the flights of conveyor belts. The scraper assemblies include a scraping element and an adjustment mechanism to move the scraping element along the conveyor belt's outer conveying surface and up the flights to scrape off material adhering to the conveying surface and the faces of the flights.

### TECHNICAL FIELD

The invention relates generally to power-driven conveyors and in particular to conveyor systems that have scrapers to scrape bulk products and residue adhering to the outer conveying surfaces and the faces of flights of conveyor belts.

### BACKGROUND

In the food industry, food products are often conveyed in bulk by conveyor belts. Belts with flights upstanding from the belts' outer conveying surfaces are often used to separate batches of the products or to convey the products on an incline or decline. Because food products in particular are often sticky, they tend to adhere to the belts' outer conveying surfaces and their flights. So products that fail to transfer off the exit end of belt conveyors must be removed. Scrapers that contact the outer conveying surfaces of belts after the exit ends of conveyors are used effectively for that purpose. But conventional scrapers are designed to scrape the outer conveying surfaces of belts without flights—not belts with flights.

### SUMMARY

One version of a conveyor system comprises a conveyor belt that extends in width in a width direction from a first side to a second side and that has an outer conveying surface and flights standing up from the outer conveying surface to top ends. The flights extend in the width direction and have leading and trailing faces in a direction of belt travel. A conveyor frame has a carryway supporting the conveyor belt along an upper run, a return below the carryway, and a reversing element that directs the conveyor belt along a reversing path from the carryway to the return. A scraper assembly includes a scraping element extending across the conveyor belt's width and an adjustment mechanism configured to move the scraping element along the outer conveying surface and up the flights to scrape the outer conveying surface and the flights as the conveyor belt advances in the direction of belt travel. The scraping is performed at least along an upper portion of the reversing path.

Another version of a conveyor system comprises a conveyor belt extending in width in a width direction from a first side to a second side. The conveyor belt has an outer conveying surface and flights that stand up from the outer conveying surface to top ends. The flights extend in the width direction and have leading and trailing faces in a direction of belt travel. A conveyor frame has a carryway supporting the conveyor belt along an upper run, a return below the carryway, and a reversing element that is rotatable on an axis of rotation and that directs the conveyor belt along a reversing path from the carryway to the return. A scraper assembly includes a scraping element extending across the conveyor belt's width and an adjustment mechanism that includes a first arm at the first side of the conveyor belt. The first arm is connected at one end to the scraping element and to a first pivot at the other end. The first pivot has a pivot axis coincident with the axis of rotation of the reversing element. The adjustment mechanism is configured to move the scraping element along the outer conveying surface and up the flights to scrape the outer conveying surface and the flights rounding the reversing element.

One version of a scraper assembly for scraping a conveyor belt with flights along a reversing path around a reversing element rotating on an axis of rotation comprises first and second arms. Each arm is pivotable about a pivot axis and positionable with respect to a conveyor belt so that the pivot axis coincides with an axis of rotation of a reversing element. Each arm has a first end and a second end. A scraping element is connected between the second ends of the first and second arms. The scraping element is movable between a first level and a different second level.

Another version of a scraper assembly comprises first and second arms, each pivotable about a pivot axis over a pivot range. Each arm has a first end and a second end. A linear scraping element is connected between the second ends of the first and second arms. The linear scraping element is movable between a first level and a different second level as the first and second arms pivot over the pivot range

### BRIEF DESCRIPTION OF THE DRAWINGS

FIG. 1 is an isometric view of a flighted belt conveyor with one version of a scraper assembly.

FIG. 2 is an isometric view of a first portion of the scraper assembly of FIG. 1 at a first side of the conveyor.

FIG. 3 is an isometric view of a second portion of the scraper assembly of FIG. 1 at a second side of the conveyor.

FIG. 4 is an exploded view of an axial-flux motor for pivoting a scraping element about a pivot axis in the scraper assembly of FIG. 2.

FIGS. 5A-5E illustrate the sequence of scraping a section of a flighted belt with the scraper assembly of FIG. 1.

FIG. 6 is an isometric view of the scraper assembly of FIG. 1 scraping a scoop flight.

FIG. 7 is an isometric view of the scraper assembly of FIG. 1 scraping a segmented flight.

FIG. 8 is an isometric view of a first version of a scraping element in a scraper assembly as in FIG. 1. FIG. 8A is a cross section of the scraping element of FIG. 8 seen along lines VIIIA-VIIIA.

FIG. 9 is an isometric view of a second version of a scraping element in a scraper assembly as in FIG. 1.

FIG. 10 is an isometric view of a third version of a scraping element in a scraper assembly as in FIG. 1.

FIG. 11 is an isometric view of a fourth version of a scraping element in a scraper assembly as in FIG. 1.

FIG. 12 is an isometric view of a fifth version of a scraping element in a scraper assembly as in FIG. 1.

FIG. 13 is an isometric view of a sixth version of a scraping element in a scraper assembly as in FIG. 1.

FIG. 14 is a schematic block diagram of an exemplary version of a control system usable with a scraper assembly as in FIG. 1.

FIG. 15 is a flowchart of the steps in a scraping sequence corresponding to the sequence shown in FIGS. 5A-5E.

FIGS. 16A-16H illustrate the sequence of scraping a flighted belt with a third version of a scraper assembly usable in a conveyor system as in FIG. 1.

FIG. 17 is an enlarged view of a portion of a guide track of the scraper assembly of FIGS. 16A-16H.

FIG. 18 illustrates from a side view the scraping sequence shown in FIGS. 16A-16H.

FIG. 19 is a side elevation view of a third version of a scraper assembly scraping a flighted conveyor belt in a return.

FIG. 20 is a side elevation view of a fourth version of a scraper assembly scraping a flighted conveyor belt in a return.

FIG. 21 is a side elevation view of a fifth version of a scraper assembly scraping a flighted conveyor belt in a return.

FIG. 22 is a side elevation view of a sixth version of a scraper assembly scraping a flighted conveyor belt in a return.

FIG. 23 is a side elevation view of a seventh version of a scraper assembly scraping a flighted conveyor belt in a return.

FIG. 24 is a side elevation view of an eighth version of a scraper assembly scraping a flighted conveyor belt in a return.

FIG. 25 is a side elevation view of a ninth version of a scraper assembly scraping a flighted conveyor belt in a return.

FIG. 26 is a side elevation view of a tenth version of a scraper assembly scraping a flighted conveyor belt in a return.

FIG. 27 is a side elevation view of an eleventh version of a scraper assembly scraping a flighted conveyor belt in a return.

FIG. 28 illustrates the sequence of scraping a flighted conveyor belt in a return with a twelfth version of a scraper assembly.

FIG. 29 illustrates the sequence of scraping a flighted conveyor belt in a return with a thirteenth version of a scraper assembly.

FIG. 30 illustrates the sequence of scraping a flighted conveyor belt in a return with a fourteenth version of a scraper assembly.

### DETAILED DESCRIPTION

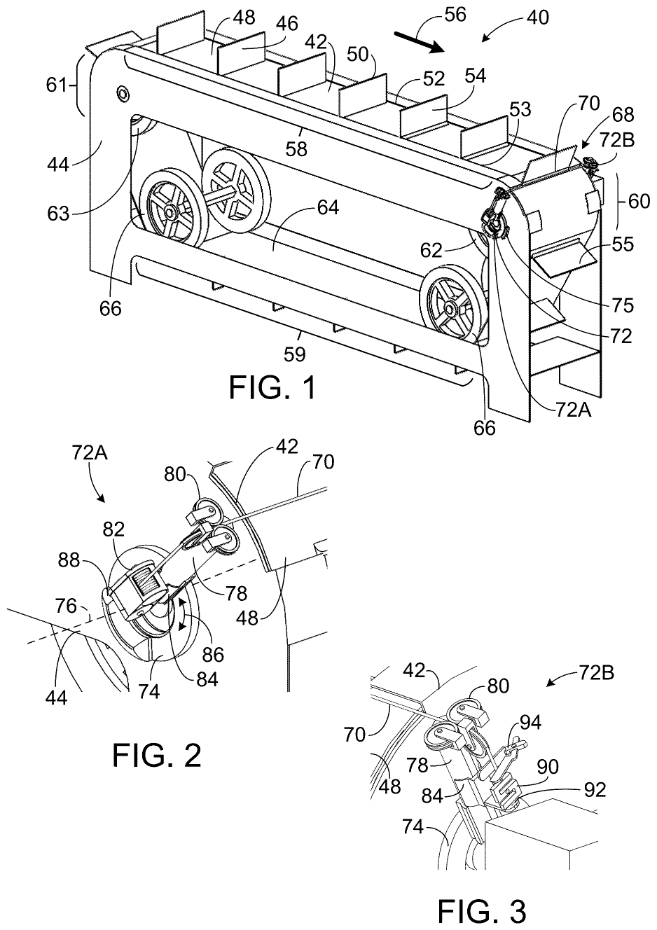

A conveyor system embodying features of the invention is shown in FIG. 1. The conveyor system 40 comprises a conveyor belt 42 mounted in a conveyor frame 44. Flights 46 stand up from an outer conveying surface 48 and extend to a top edge 50. The flights 46 extend in a width direction across the conveyor belt between a first side 52 of the belt and a second side 53. Each flight 46 has a leading face 54 and a trailing face 55 in a direction of belt travel 56.

The conveyor belt 42 is driven conventionally in a continuous loop that includes an upper carryway segment 58, a lower return segment 59, and first and second reversing segments 60, 61 between the carryway and the return. A reversing element 62, such as a motorized sprocket set, a motorized pulley, or a drum motor, drivingly engages the inner side 64 of the conveyor belt 42 in the reversing segment 60 to drive the belt in the direction of belt travel 56. The conveyor belt's loop is defined by return roller sets 66, a second reversing element 63, such as an idle sprocket or pulley set, and the first reversing element 62. It is possible to drive the conveyor belt 42 in the return 59 or with the second reversing element 63. In those cases the first reversing element 61 would be an idle sprocket or pulley set, for example, instead of a driver for the belt.

A scraper assembly 68 mounted in the conveyor frame 44 at the first reversing segment 60 has a scraping element 70 that extends across the width of the conveyor system 40. The position of the scraping element 70 is adjusted by an adjustment mechanism 72 that has a first portion 72A mounted on one side of the conveyor frame 44 and a second portion 72B mounted at the outer side. The scraping element 70 extends across the width of the belt 42 from the first portion 72A to the second portion 72B.

The first portion 72A of the adjustment mechanism 72 is shown in more detail in FIG. 2. The first portion 72A includes a rotary motor 74 defining a pivot axis 76 through its center. A mounting bracket 84 is attached to the rotary motor 74. A linear actuator 78 is attached at one end to the mounting bracket 84. A pulley system 80 attached to the distal end of the linear actuator 78 guides the scraping element 70, a linear scraping element, such as a cable or wire in this example, from a cable motor and winch 82 across the width of the belt 42 to the second portion of the adjustment mechanism 72. A linear encoder in the linear actuator 78 measures the extension of the linear actuator between a retracted position (shown in FIG. 2) and an extended position.

The rotary motor 74 pivots the linear actuator 78, the winch 82, the pulley system 80, and the scraping element 70 about the pivot axis 76 over a range of pivot angles as indicated by the arrow 86. Thus, the rotary motor 74 moves the scraping element 70 along the length of the conveyor belt 42. Because the pivot axis 76 of the scraper assembly 68 coincides with the axis of rotation of the reversing element 62, the scraping element 70 scrapes the outer conveying surface 48 of the belt 42 while the linear actuator 78 is retracted. For smooth operation, a counterweight 88 on the rotary motor 74 helps balance the motor by offsetting the combined weights of the winch 82, the pulleys 80, and the linear actuator 78, as well as tension in the scraping element 70.

The second portion 72B of the adjustment mechanism 72 is shown in detail in FIG. 3. Like the first portion, the second portion includes a linear actuator 78 with a linear encoder, a pulley system 80, a rotary motor 74, and a mounting bracket 84. Both portions operate similarly. And the linear actuator 78 in each portion serves as an extensible arm from which the scraping element 70 is strung across the width of the belt 42.

The linear scraping element cable or wire 70 is attached at one end to a load cell 90 affixed to a support bracket 92 on the linear actuator 78. The load cell 90 measures the tension in the cable or wire 70. When the tension exceeds a predetermined tension value, a shear 94 cuts the cable or wire 70 to prevent damage to the belt 42. The pivot axis 76 of the first portion 72A (FIG. 2) is the pivot axis of the second portion 72B.

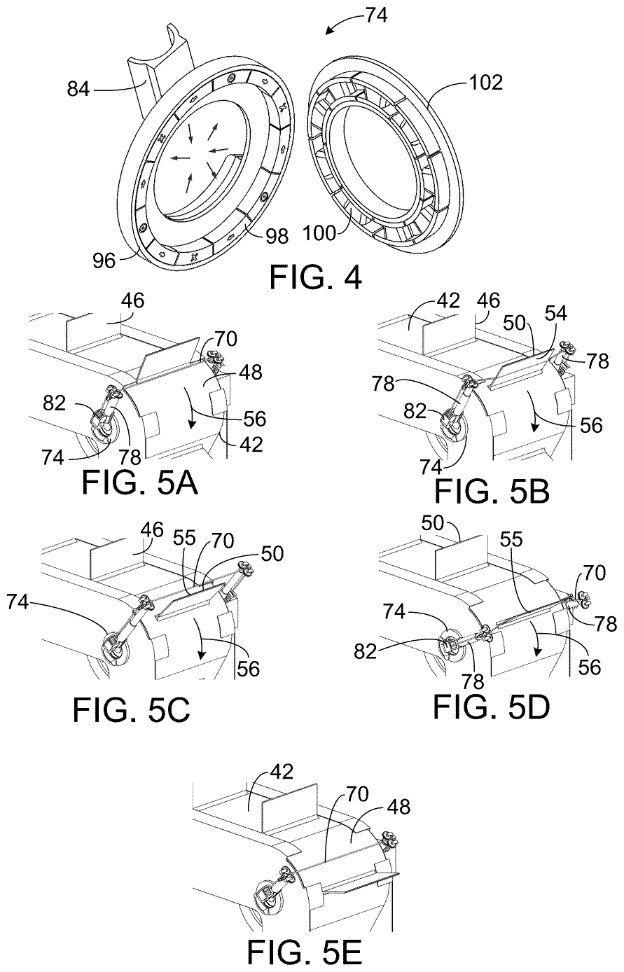

The rotary motor 74 is shown in more detail in FIG. 4. The motor 74 includes a rotor 96 attached to the mounting bracket 84 for the linear actuator. The magnetic field of a ring of permanent magnets 98, preferably arranged in a Halbach array, interacts with the electromagnetic field produced by stator coils 100 in a stator 102 affixed to the conveyor frame 44 (FIG. 2). When the stator 102 is energized, the rotor 96 is caused to rotate and change the pivot angle. A rotary encoder 75 (FIG. 1) mounted to the rotary motor 74 measures the pivot angle of the rotor 96.

The sequence of scraping a region of the flighted conveyor belt 42 in a reversing path between the carryway and the return is shown in FIGS. 5A-5E and is further described in the flowchart of FIG. 15. In particular, the scraping occurs in the reversing path in an upper portion closer to the carryway than to the return below.

In Phase 1 of the scraping sequence, as illustrated in FIG. 5A, the linear actuators 78 are in the retracted position to position the scraping element 70 on the outer conveying surface 48 of the conveyor belt 42. The rotary motors 74 pivot the linear actuators 78 and the scraping element 70 opposite the direction of belt travel 56. The winch 82 tightens the cable scraping element 70 to a predetermined tension set point to scrape residue from the outer conveying surface 48.

In Phase 2, illustrated in FIG. 5B, the linear actuators 78 extend from the retracted position through intermediate positions up the leading face 54 of the flight 46 to its top edge 50. While the linear actuators 78 move the scraping element 70 up the flight's leading face 54, the rotary motors 74 pivot the linear actuators and the scraping element at a speed slightly less than the forward speed of the conveyor belt 42 in the direction of belt travel 56. With the winch 82 maintaining the cable tension at the predetermined set point, the scraping element scrapes the leading face 54 of the flight 46.

In Phase 3, illustrated in FIG. 5C, the tension in the cable scraping element 70 drops to zero when it clears the top edge 50 of the flight 46. The linear actuators 78 are at extended positions. The rotary motors 74 pivot the linear actuators 78 and the scraping element forward in the direction of belt travel 56 at a speed slightly greater than the speed of the belt 42 for the scraping element 70 to catch up to the trailing face 55 of the advancing flight 46.

In Phase 4, illustrated in FIG. 5D, the scraping element 70 scrapes the flight's trailing face 55 from its top edge 50 down to its base at the belt's outer conveying surface 48. The linear actuators 70 move the scraping element 70 through intermediate positions down the trailing face 55 toward the retracted position. The rotary motors 74 continue to pivot the scraping element 70 forward in the direction of belt travel 56 at a speed slightly greater than the belt speed. The winch 82 maintains the tension in the cable scraping element 70 at the predetermined set point.

FIG. 5E shows the scraping element 70 returned to its position to scrape the outer conveying surface 48 of the conveyor belt 42 as in Phase 1 and FIG. 5A.

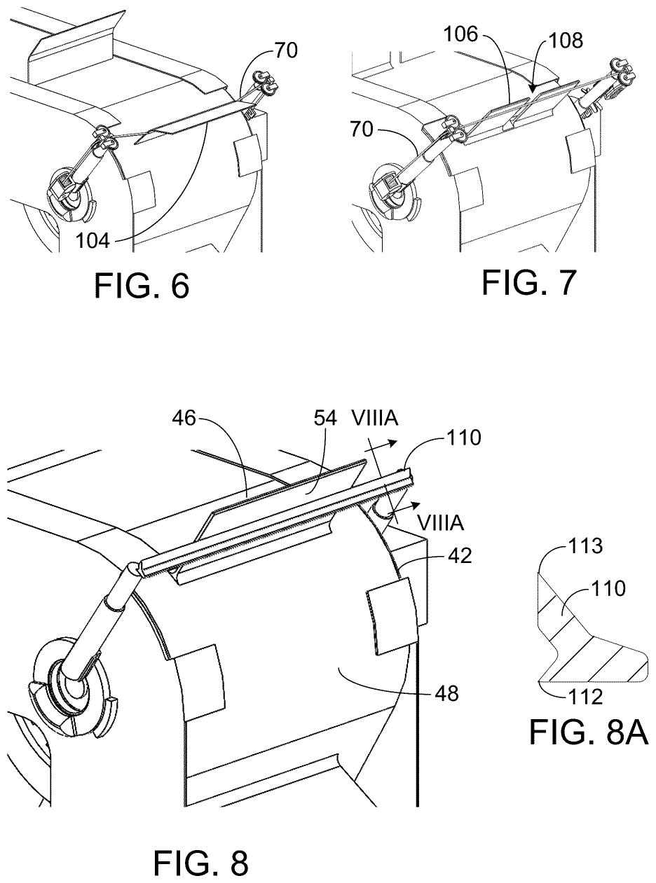

FIG. 6 shows the cable scraping element 70 scraping a scoop flight 104. FIG. 7 shows the cable scraping element 70 scraping a segmented flight 106 with an intermediate gap 108.

FIGS. 8-13 show scraping elements that are different from the cable of FIGS. 1-3 and FIGS. 5-7.

FIG. 8 shows a scraping element 110 with two blades, better shown in FIG. 8A. A first blade 112 at the bottom scrapes the outer conveying surface 48 of the belt 42. A second blade 113 at the top scrapes the leading face 54 of the flight 46.

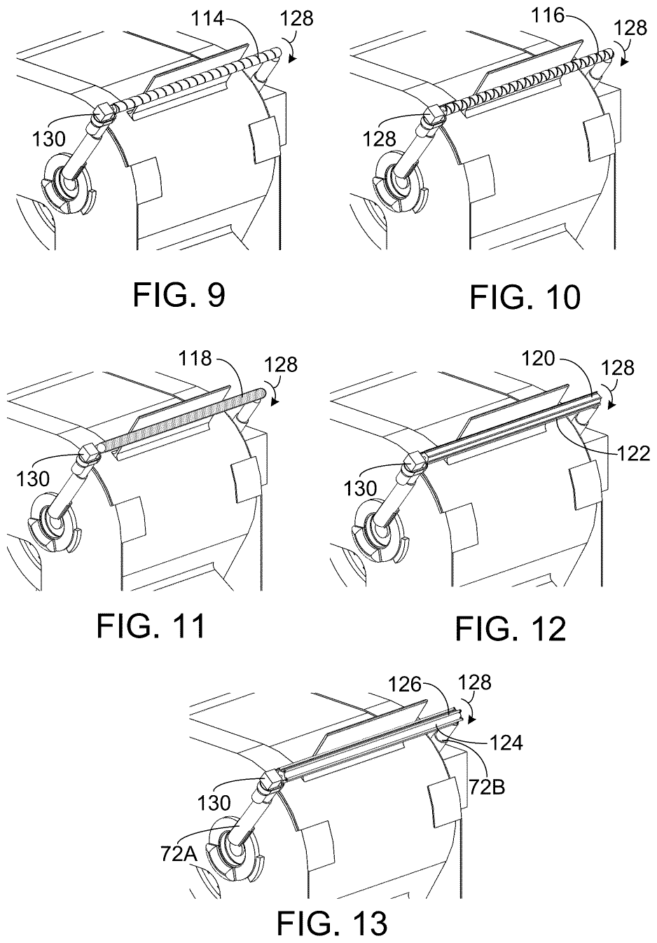

FIG. 9 shows a scraping element 114 with a helical scraping surface; and FIG. 10 shows a scraping element 116 with a double-helical scraping surface.

The scraping surface of the scraping element 118 in FIG. 11 is mildly abrasive. The scraping element 120 in FIG. 12 is a paddle-wheel scraper with protruding paddles 122 that extend across the width of the belt 42. The scraping element 124 in FIG. 13 is formed by a set of cables or rods 126 that extend from the first portion 72A of the adjustment mechanism to the second portion 72B. The scraping elements in FIGS. 9-13 are rotary scrapers that are rotated in the directions of the arrows 128 by a motor 130 at the distal end of the linear actuators in one of the first and second portions 72A, 72B.

Other scraping elements usable in the adjustment mechanisms include wipers, rods, blades, arrays of parallel cables or wires, and arrays of parallel rods.

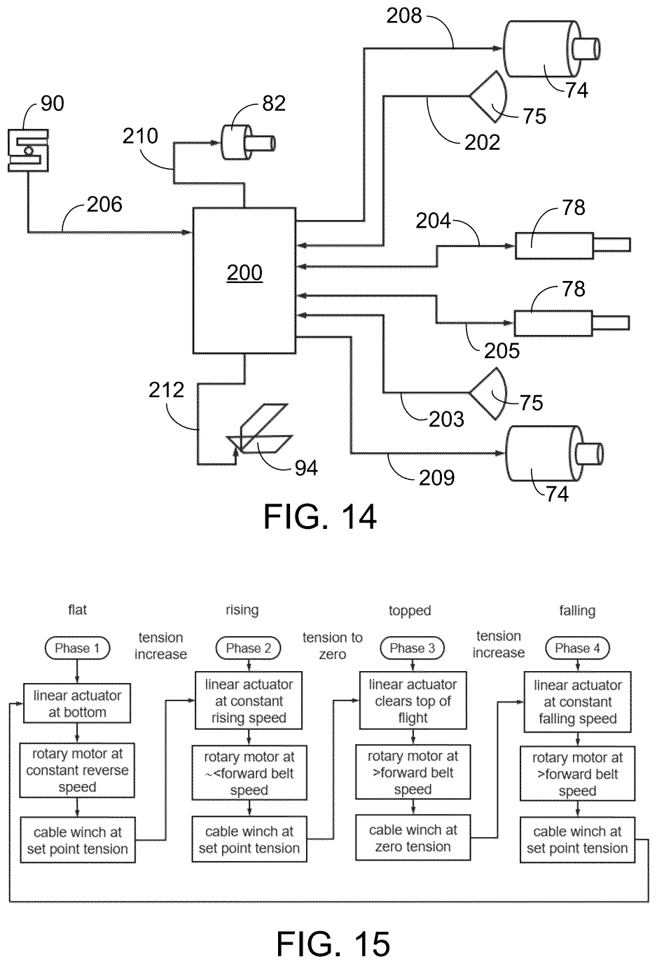

A block diagram of a control system usable with the scraper assembly 72 of FIG. 1 is shown in FIG. 14. The control system includes a processor 200 such as a programable logic controller, a microprocessor, or other processing unit, that is programmed to execute instructions that control the scraper assembly. The processor 200 receives the pivot-angle signals sent from the rotary encoders 75 in each portion of the scraper assembly over lines 202, 203. The linear encoders in the linear actuators 78 send extension signals to the processor 200 over lines 204, 205. And the load cell 90 sends tension signals to the processor 200 over line 206.

To control the scraping elements as described in reference to FIGS. 5A-5E and FIG. 15, the processor 200 executes program instructions to send pivot signals to the rotary motors 74 over output lines 208, 209 to control the pivot angle and the positioning of the scraping element relative to the belt as it advances on the reversing element. Similarly, the processor 200 executes program instructions to send extension signals over lines 204, 205 to the linear actuators 78 to control the extension of the scraping element from the retracted position at a first level relative to the outer conveying surface of the belt and the extended position at a second level. The processor 200 coordinates the pivoting of the rotary motors 74 with the extension of the linear actuators 78 based on the pivot-angle signals from the rotary encoders 75 and the extension signals from the linear encoders to scrape the outer conveying surface of the flighted conveyor belt as it advances around the reversing element. Where the scraping element is a cable, the processor coordinates the loosening and tightening of the scraping element with the motion of the linear actuators 78 and the rotary motors 74 with a winch signal to the winch 82 over line 210 to adjust the tightness of the cable.

If the scraping element should somehow stop the belt and cause the tension in the cable to rise above a predetermined tension value as measured by the load cell 90, the processor will execute program instructions to send a shear signal over line 212 to the shear 94 to cut the cable and free the belt.

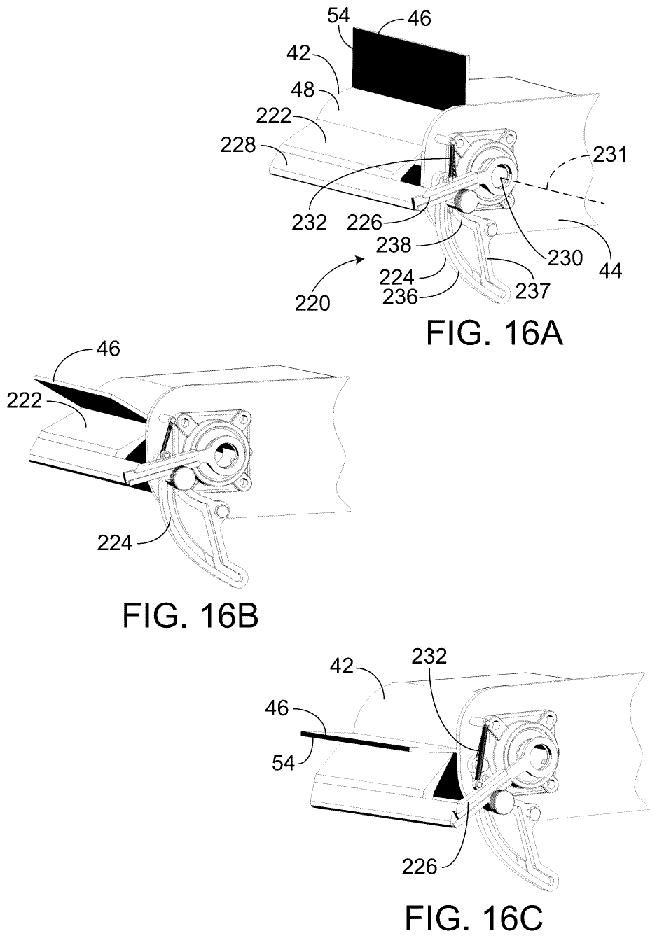

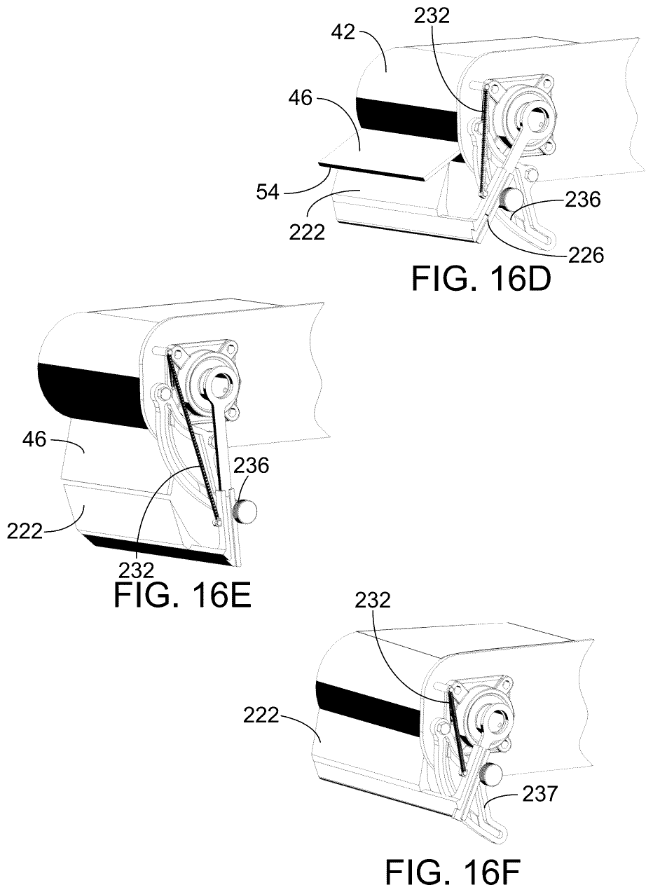

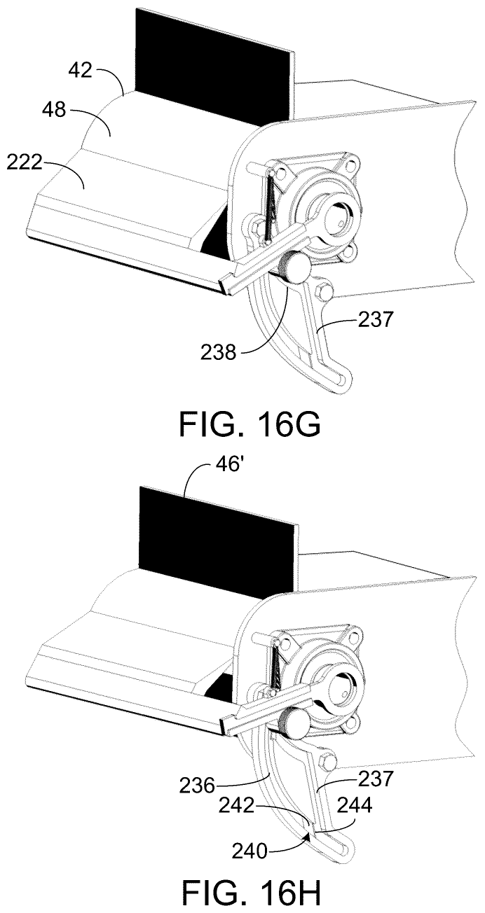

Another version of a scraper assembly 220 for a flighted belt is shown in operation in FIGS. 16A-16H. The motion of the scraping element 222 in a reversing path is defined by a first guide track 224 that correlates with the radius of curvature of the belt 42 on the reversing element and the height of the flight 46. In this version the scraping occurs over both upper and lower portions of the reversing path. The upper portion is closer to the carryway than to the return, and the lower portion is closer to the return than to the carryway. The scraper assembly 220 has an arm 226 supporting the scraping element 222 through a holder 228. The holder 228 allows for replacement of worn scraping elements 222. One end of the arm 226 is connected to the scraping element 222 through the holder 228. The other end of the arm 226 is attached to a pivot 230 on the conveyor frame 44. The pivot axis 231 is collinear with the axis of rotation of the reversing element. A coil spring 232 connected between the conveyor frame 44 and the arm 226 biases the scraping element 222 against the belt 42 and the front face 54 of the flight 46.

Unlike the scraper assembly 72 of FIG. 1, the scraper assembly of FIGS. 16A-16H and 19 is not pivoted by a rotary motor. Nor is its scraping element extended and retracted by a linear actuator. Rather, the activation force causing the motion of the scraping element 222 results from its contact with the flighted belt 42 advancing around the reversing element. The guide track 224 and the spring 232 ensure that the scraping element 222 snugly follows the outer conveying surface 48 of the belt 42 and the flight 46. The adjustment mechanism adjusts the position of the scraping element 222 in response to the activation force applied to the scraping element by the advancing flights 46.

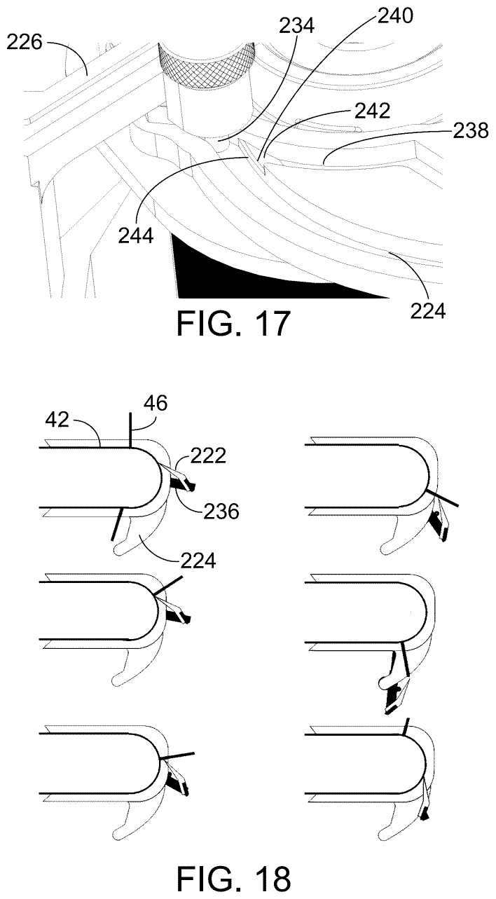

The operation of the scraper assembly 220 is described in reference to FIGS. 16A-16H and FIGS. 17 and 18. As FIG. 17 shows, the scraper assembly 220 has a pin 234 affixed to the arm 226. The pin 234 rides in the guide track 224. As shown in FIG. 16A, the guide track 224 includes an outwardly convex track segment 236, a linear track segment 237, and an outwardly concave track segment 238. Each of the three segments 236, 237, 238 meet at individual junctions to form a closed track circuit.

The scraping sequence is described with respect to FIGS. 16A-16H and FIG. 18. In FIG. 16A, the scraping element 220 is shown scraping the outer conveying surface 48 of the belt 42. The pin (234, FIG. 17) is received in the upper end of the outwardly convex segment 236 of the guide track 224. The pin 234 remains in that position until the scraping element 222 encounters the base of the flight 46 as in FIG. 16B. As the belt 42 continues to advance around the reversing element, the flight 46 exerts a force against the scraping element 222 that deflects the arm 226 downward and stretches the spring 232, as shown in FIGS. 16C and 16D. At the same time, the force continues to move the pin 234 farther along the outwardly convex track segment 236 as the scraping element 222 is pushed along the leading face 54 of the flight 46 toward its top 50.

Once the scraping element 222 has cleared the flight 46, the spring 232 is maximally stretched with the pin 234 at the end of the outwardly convex track segment 236 as in FIG. 16E. Because the scraping element 222 is no longer in contact with the flight 46 or the belt 42 itself, the stretched spring 232 pulls the arm 226 with the affixed pin 234 up the linear track segment 237 and the outwardly concave track segment 238 as shown in FIGS. 16F and 16G until the scraping element 222 is once again contacting and scraping the outer conveying surface 48 of the conveyor belt 42. The pin 234 finally returns to its home position at the outwardly convex track segment 236 in FIG. 16H, which is the same as in FIG. 16A, to repeat the scraping process for the next flight 46′.

A ramp stop 240 with a ramp 242 and a stop face 244 is positioned in the outwardly convex segment 236 just ahead of its junction with the linear track segment 237 as shown in FIG. 16H. The stop face 244 blocks the pin 234 from reversing up the outwardly convex segment 236 and guides it into the linear track segment 237. The wedge-shaped ramp 242 rises from an upstream position in the outwardly convex track segment 236 to form the ramp's stop face 244, as shown in FIG. 16H, for example.

A similar ramp stop 240 with a ramp 242 and a stop face 244 is shown in greater detail in FIG. 17. The ramp stop 240 is positioned in the outwardly concave track segment 238 at its junction with the outwardly convex track segment 236. The stop face 244 blocks the pin 234 from reversing down the outwardly concave track segment 238 from the home position at the top of the outwardly convex track segment 236. The combinations of the ramps 242 with the stop faces 244 ensure that the pin 234 follows only a counterclockwise path around the guide-track circuit.

Although FIGS. 16A-18 show a scraper assembly 220 with a first portion supporting the scraping element 222 at only one end, a complete scraper assembly could include a mirror-image second portion supporting the other end of the scraping element at the other side of the conveyor. The one-sided scraper, while it can be effective at cleaning narrow belts, is not as effective on wide belts for which first and second portions of the scraper assembly are useful. And unlike the scraper assembly 72 of FIG. 1, the scraper assembly 220 of FIGS. 16A-17 does not scrape the trailing faces of flights.

The scraper assemblies of FIGS. 19-30 are designed to scrape the conveyor belt 42 and flights 46 in the return, instead of at the reversing element. And these scraper assemblies each rely on the force of the advancing flights against the scraping element to move the scraping element from a first level against the outer conveying surface of the belt along the leading faces of the flights to a second level clear of the tops of the flights. Like the adjustment mechanism in the scraper assembly of FIG. 16A-16H, the adjustment mechanisms in FIGS. 19-30 adjust the position of the scraping element in response to the activation force applied to the scraping element by the advancing flights 46—not around the reversing element, but in the return.

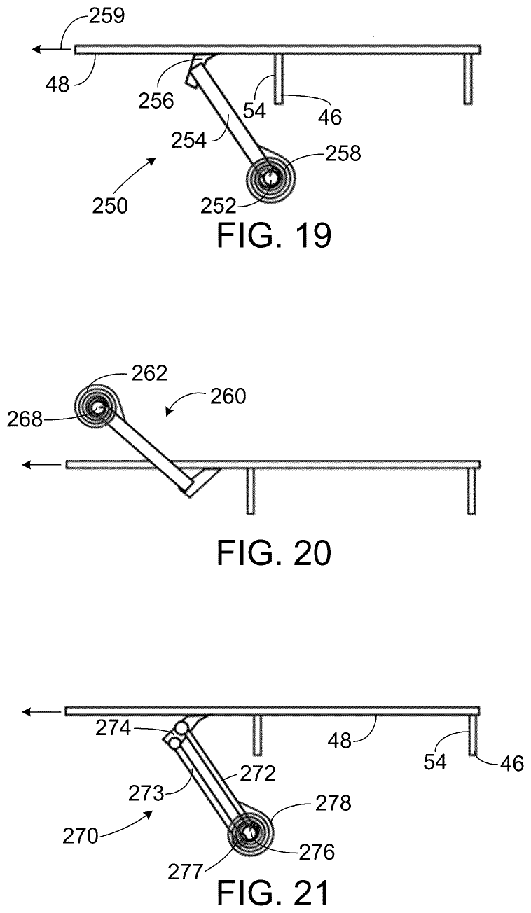

The adjustment mechanism in the scraper assembly 250 in FIG. 19 has a pivot 252 below the belt return path affixed to one end of an arm 254. The other end of the arm is attached to the scraping element 256. A helical spring 258, i.e., a clock spring, is attached between the conveyor frame and the arm 254. The spring 258 biases the scraping element against the belt's outer conveying surface 48 and the leading face 54 of the flight 46 as the belt advances along the return in a direction of belt travel 259. The scraper assembly 260 in FIG. 20 is similar to that of FIG. 19, except that the pivot 262 and the clock spring 268 are positioned above the belt return.

The adjustment mechanism in the scraper assembly 270 shown in FIG. 21 is similar to that of FIG. 19, except that it includes two arms 272, 273. First ends of the arms 272, 273 are pivotally connected to the scraping element 244 at spaced-apart points. The second ends of the arms 272, 273 are attached to spaced-apart pivots 276, 277. The conveyor frame between the two pivots 276, 277, the scraping element 274, and the two arms 272, 273 form a four-bar linkage. A helical spring 278 connected between the conveyor frame and the first arm 272 biases the scraping element 274 against the outer surface 48 and the leading face 54 of the flight 46.

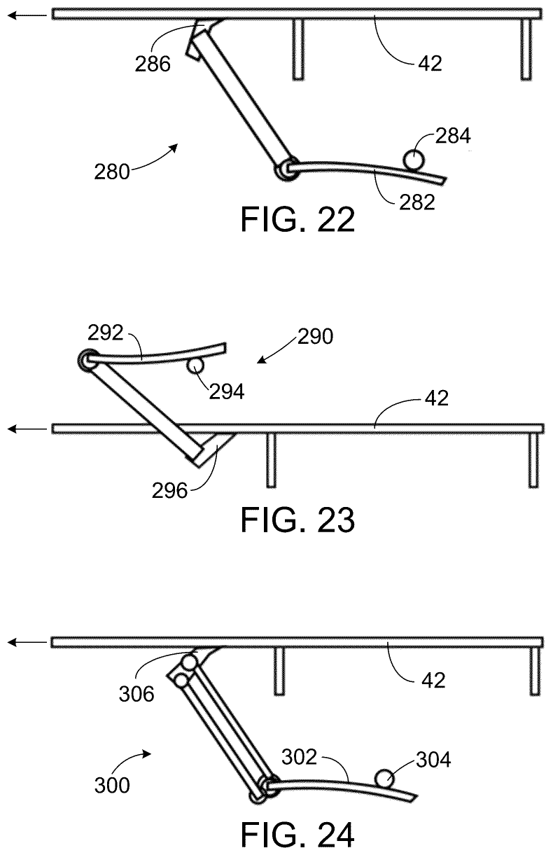

FIGS. 22-24 depict scraper assemblies 280, 290, 300 with adjustment mechanisms that use leaf springs 282, 292, 302 and spring stops 284, 294, 304 instead of the clock springs 258, 268, 278 of FIGS. 19-21 to bias scraping elements 286, 296, 306 against the flighted belt 42.

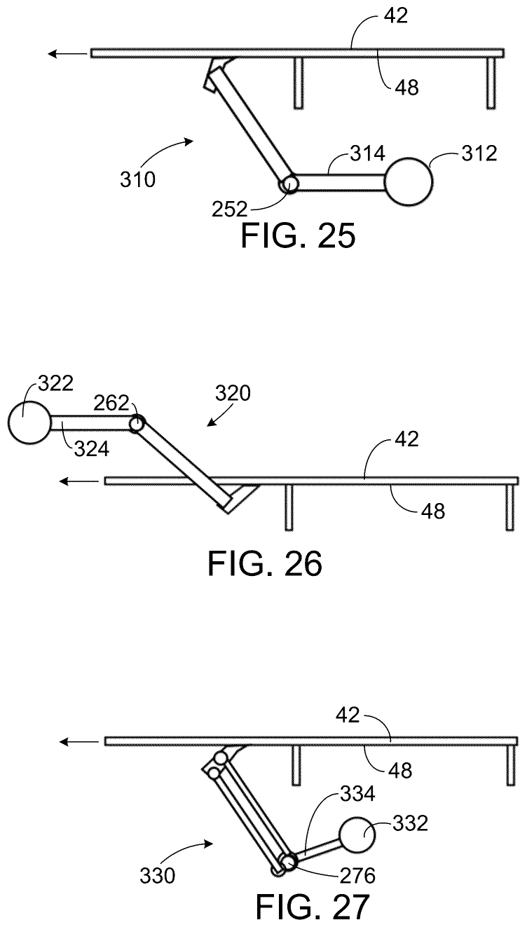

FIGS. 25-27 depict scraper assemblies 310, 320, 330 with adjustment mechanisms that use counterweights 312, 322, 332 at the ends of arms 314, 324, 334. The other ends of the counterweight arms 314, 324, 334 are attached to the pivots 252, 262, 276. The counterweights 312, 322, 332 bias the scraping elements 316, 326, 336 against the outer conveying surface 48 of the flighted belt 42.

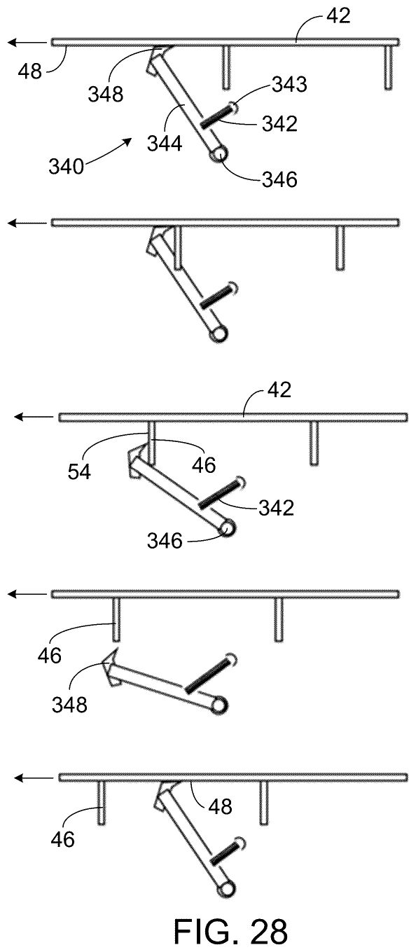

FIG. 28 shows the scraping sequence of a scraper assembly 340 whose adjustment mechanism uses a coil spring 342 connected between an anchor point 343 on the conveyor frame and a point on an arm 344 that is connected at one end to a pivot 346 below the return and at the other end to a scraping element 348. The coil spring 342 biases the scraping element against the outer conveying surface 48 of the belt 42 and the leading face 54 of the flight 46. The scraping sequence shows how the scraping element's encounter with the flight 46 stretches the coil spring 342 as the arm 344 pivots about the pivot 346. Once the scraping element 348 has cleared the flight 46, the coil spring 342 draws the scraping element back against the belt's outer conveying surface 48 behind the scraped flight.

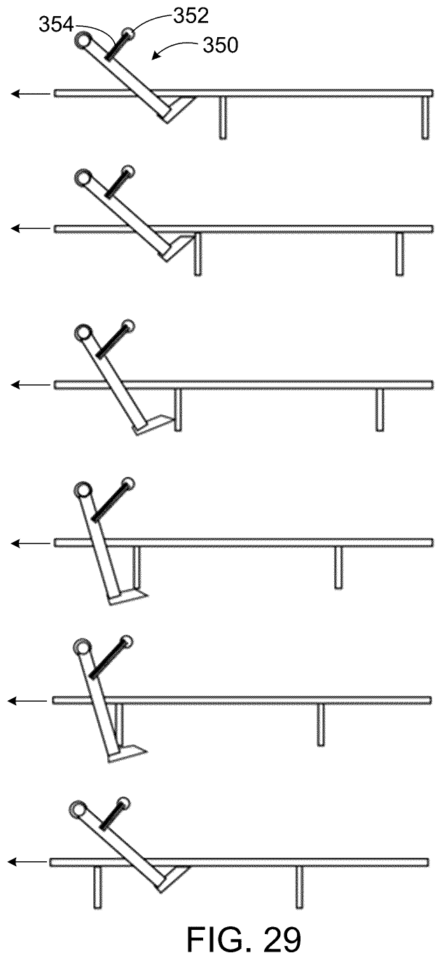

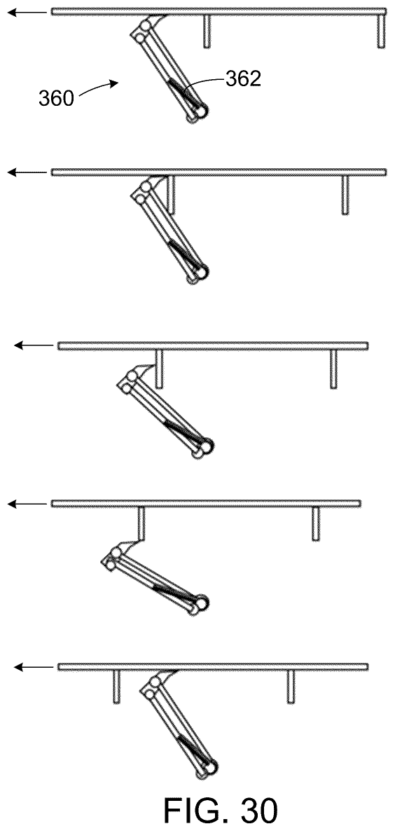

FIG. 29 depicts a scraping sequence for a scraper assembly 350 in which the adjustment mechanism includes a pivot 352 and a coil spring 354 that reside above the belt return. Otherwise, it operates in essentially the same way as the scraper assembly 340 of FIG. 28. And the scraper assembly 360 in FIG. 30 with the four-bar linkage structure uses a coil spring 362 in the same way as the scraper assemblies 340, 350 of FIGS. 28 and 29.

All the scraper assemblies shown in FIGS. 19-30 are shown for simplicity with a single scraper portion at one side of the conveyor. Although these assemblies could be operated one-sided for narrow belts, most applications would require a mirror-image second portion at the other side of the belt so that the scraping element is supported at both ends. And linear scraping elements, such as cables, wires, and rods, can be used in two-sided versions.

What is claimed is:

1. A conveyor system comprising:
a conveyor belt extending in width in a width direction from a first side to a second side and having an outer conveying surface and flights standing up from the outer conveying surface to top ends and extending in the width direction and having leading and trailing faces in a direction of belt travel;
a conveyor frame having a carryway supporting the conveyor belt along an upper run, a return below the carryway, and a reversing element that directs the conveyor belt along a reversing path from the carryway to the return;
a scraper assembly including:
a scraping element extending across the conveyor belt's width;
an adjustment mechanism configured to move the scraping element along the outer conveying surface and up the flights to scrape the outer conveying surface and the flights as the conveyor belt advances in the direction of belt travel, wherein the scraping is performed at least along an upper portion of the reversing path.

2. The conveyor system as claimed in claim 1 wherein the adjustment mechanism includes:
a first portion attached to the conveyor frame at the first side of the conveyor belt and a second portion attached to the conveyor frame at the second side of the conveyor belt;
wherein the first portion is pivotable about a pivot axis and the second portion is pivotable with the first portion about the pivot axis;
wherein the first portion includes a first extensible arm having a first end and a second end farther from the pivot axis than the first end and wherein the second portion includes a second extensible arm having a first end and a second end farther from the pivot axis than the first end;
wherein the scraping element spans the width of the conveyor belt from the second ends of the first and second extensible arms;
wherein the first and second extensible arms are pivotable about the pivot axis and extensible from a retracted position positioning the scraping element against the outer conveying surface of the conveyor belt, through intermediate positions positioning the scraping element against the leading faces of the flights as the conveyor advances in the conveying direction, to an extended position past the top ends of the flights.

3. The conveyor system as claimed in claim 2 wherein the first and second extensible arms comprise linear actuators that each include a linear encoder to measure the extension of the linear actuator between the retracted position and the extended position.

4. The conveyor system as claimed in claim 2 wherein the first portion includes a rotary motor connected to the first and second extensible arms to pivot the scraping element about the pivot axis through a range of pivot angles.

5. The conveyor system as claimed in claim 4 wherein the first portion includes a counterweight on the rotary motor.

6. The conveyor system as claimed in claim 2 wherein the scraping element is a cable strung between the first and second portions.

7. The conveyor system as claimed in claim 6 wherein one of the first and second portions includes a winch for loosening and tightening the cable.

8. The conveyor system as claimed in claim 6 including a load cell in one of the first and second portions connected to the cable to measure tension in the cable.

9. The conveyor system as claimed in claim 8 including a shear in one of the first and second portions positioned to cut the cable if the tension measured by the load cell exceeds a predetermined tension value.

10. The conveyor system as claimed in claim 2 comprising a processor, wherein:
the first and second extensible arms comprise linear actuators that each include a linear encoder to measure the extension of the extensible arm between the retracted position and the extended position and to send extension signals indicative of the extension to the processor;
the first portion includes a rotary motor to pivot the scraping element about the pivot axis through a range of pivot angles;
a rotary encoder on the rotary motor senses the pivot angle and sends pivot-angle signals indicative of the pivot angle to the processor;
the processor receives the extension signals from the linear encoders and the pivot-angle signals from the rotary encoders and is programmed to execute program instructions to control the scraper assembly.

11. The conveyor system as claimed in claim 10 wherein the processor is programmed execute program instructions to:
control the rotary motor and the pivot angle based on the pivot-angle signals by sending pivot signals to the rotary motor; and
control the linear actuators and the extensions of the first and second extensible arms based on the extension signals by sending linear-actuator signals to the first and second linear actuators.

12. The conveyor system as claimed in claim 10 wherein the scraping element is a cable and wherein one of the first and second portions includes a motorized winch for loosening and tightening the cable and wherein the processor is programmed to execute program instructions to send a winch signal to the motorized winch to loosen or tighten the cable based on the pivot-angle signals and the extension signals.

13. The conveyor system as claimed in claim 12 wherein the adjustment mechanism includes:
a load cell in one of the first and second portions and connected to the cable to measure tension in the cable and send tension signals to the processor;
a shear in one of the first and second portions positioned to selectively cut the cable;
wherein the processor is programmed to execute program instructions to send a cut signal to the shear to cut the cable if the tension signal sent by the load cell indicates a tension in the cable that exceeds a predetermined tension value.

14. The conveyor system as claimed in claim 10 wherein the processor is programmed to execute program instructions to control the position of the scraping element as follows:
(a) by sending linear-actuator signals to the first and second linear actuators to assume the retracted position and by sending pivot-angle signals to the rotary motor to move the scraping element opposite the direction of belt travel to scrape the outer conveying surface of the conveyor belt advancing from the carryway to the return at the reversing element;
(b) by sending linear-actuator signals to the first and second linear actuators to move toward the extended position and by sending pivot-angle signals to the rotary motor to move the scraping element in the direction of belt travel at a speed less than the speed of the conveyor belt to scrape upward along the leading face of a flight advancing from the carryway to the return at the reversing element.

15. The conveyor system as claimed in claim 14 wherein the processor is programmed to execute program instructions to control the position of the scraping element after step (b) by sending linear-actuator signals to the first and second linear actuators to move toward the retracted position and by sending pivot-angle signals to the rotary motor to move the scraping element in the direction of belt travel at a speed greater than the speed of the conveyor belt to scrape downward along the trailing face of the flight advancing from the carryway to the return at the reversing element.

16. The conveyor system as claimed in claim 1 wherein the scraping element extends across the width of the conveyor belt from a first portion of the adjustment mechanism that includes:
a pivot pivotable on a pivot axis;
a first arm having a first end connected to the pivot and second end connected to a first end of the scraping element;
wherein the first arm is configured to pivot about the pivot axis in response to the force acting on the scraping element by the flights as the conveyor belt advances relative to the pivot.

17. The conveyor system as claimed in claim 16 wherein the scraping element extends across the width of the conveyor belt from a first portion of the adjustment mechanism to a second portion of the adjustment mechanism that is connected to a second end of the scraping element and is a mirror-image of the first portion.

18. The conveyor system as claimed in claim 1 wherein the scraping element extends across the width of the conveyor belt from a first portion of the adjustment mechanism that includes:
a pivot;
an arm having a first end connected to the pivot and a second end connected to a first end of the scraping element;
a pin attached to the arm between the first and second ends of the arm;
a fixed guide track receiving the pin and providing a path for the pin that guides the arm as the scraping element moves along the outer conveying surface and the flights.

19. The conveyor system as claimed in claim 18 wherein the scraping element extends across the width of the conveyor belt from the first portion of the adjustment mechanism to a second portion of the adjustment mechanism that is connected to a second end of the scraping element and is a mirror-image of the first portion.

20. The conveyor system as claimed in claim 19 wherein the first and second portions each include a spring coupled to the arm to bias the scraping element toward the outer conveying surface of the conveyor belt.

21. The conveyor system as claimed in claim 18 wherein the guide track includes an outwardly convex track segment, a linear track segment, and an outwardly concave track segment, wherein each pair of segments meet at individual junctions to form a closed track circuit.

22. The conveyor system as claimed in claim 18 wherein the guide track includes:
a first ramp stop having a ramp and a stop face at a first junction of the outwardly convex track segment with the outwardly concave track segment to allow the pin to move up and over the ramp of the first ramp stop from the outwardly concave track segment to the outwardly convex track segment and to block the pin from entering the outwardly concave track segment from the outwardly convex track segment with the stop face of the first ramp stop; and
a second ramp stop having a ramp and a stop face at a second junction of the outwardly convex track segment with the linear track segment to allow the pin to move up and over the ramp of the second ramp stop in the outwardly convex track segment and to block the pin from reentering the outwardly convex track segment once the pin has crossed the second ramp stop with the stop face of the second ramp stop.

23. The conveyor system as claimed in claim 18 wherein the pin moves along the outwardly convex track segment as the scraping element scrapes the outer conveying surface rounding the reversing element, moves along the linear track segment as the scraping element scrapes the leading face of the flights, and moves along the outwardly concave segment as the scraping element clears the flights to return into position against the outer conveying surface.

24. The conveyor system as claimed in claim 1 wherein the scraping is also performed along a lower portion of the reversing path.

25. A conveyor system comprising:
a conveyor belt extending in width in a width direction from a first side to a second side and having an outer conveying surface and flights standing up from the outer conveying surface to top ends and extending in the width direction and having leading and trailing faces in a direction of belt travel;
a conveyor frame having a carryway supporting the conveyor belt along an upper run, a return below the carryway, and a reversing element that is rotatable on an axis of rotation and that directs the conveyor belt along a reversing path from the carryway to the return;
a scraper assembly including:
a scraping element extending across the conveyor belt's width;
an adjustment mechanism including a first arm at the first side of the conveyor belt, the first arm connected at one end to the scraping element and to a first pivot at the other end, wherein the first pivot has a pivot axis coincident with the axis of rotation of the reversing element;
wherein the adjustment mechanism is configured to move the scraping element along the outer conveying surface and up the flights to scrape the outer conveying surface and the flights rounding the reversing element.

26. The conveyor system as claimed in claim 25 wherein the adjustment mechanism includes a second arm at the second side of the conveyor belt, wherein the second arm is connected at one end to the scraping element and to a pivot at the other end, wherein the pivot has a pivot axis coincident with the axis of rotation of the reversing element.

27. The conveyor system as claimed in claim 26 wherein the first and second arms are extensible from a retracted position to an extended position.

28. The conveyor system as claimed in claim 27 wherein the first and second arms comprise linear actuators that each include a linear encoder to measure the extension of the first and second arms between the retracted position and the extended position.

29. The conveyor system as claimed in claim 25 wherein the scraping element extends across the width of the conveyor belt from a first portion of the adjustment mechanism that includes:
a pivot;
an arm having a first end connected to the pivot and a second end connected to a first end of the scraping element;
a pin attached to the arm between the first and second ends of the arm;
a fixed guide track receiving the pin and providing a path for the pin that guides the arm as the scraping element moves along the outer conveying surface and the flights.

30. The conveyor system as claimed in claim 29 wherein the scraping element extends across the width of the conveyor belt from the first portion of the adjustment mechanism to a second portion of the adjustment mechanism that is connected to a second end of the scraping element and is a mirror-image of the first portion.

31. A scraper assembly for scraping a conveyor belt with flights along a reversing path around a reversing element rotating on an axis of rotation, the scraper assembly comprising:
first and second arms, each pivotable about a pivot axis and positionable with respect to a conveyor belt so that the pivot axis coincides with an axis of rotation of a reversing element and having a first end and a second end;
a scraping element connected between the second ends of the first and second arms;
wherein the scraping element is movable between a first level and a different second level.

32. The scraper assembly as claimed in claim 31 comprising a rotary motor connected to the first end of one of the first and second arms to pivot the first and second arms about the pivot axis through a range of pivot angles.

33. The scraper assembly as claimed in claim 31 wherein the first and second arms are pivotable about the pivot axis and extensible between a retracted position to position the scraping element at the first level and an extended position to position the scraping element at the second level.

34. The scraper assembly as claimed in claim 33 wherein the first and second arms each include a linear actuator and a linear encoder to measure the extension of the linear actuator between the retracted position and the extended position.

35. The scraper assembly as claimed in claim 31 wherein the scraping element is a cable strung between the first and second arms.

36. The scraper assembly as claimed in claim 35 comprising a winch associated with the first arm for loosening and tightening the cable.

37. The scraper assembly as claimed in claim 35 including a load cell associated with one of the first and second arms connected to the cable to measure tension in the cable.

38. The scraper assembly as claimed in claim 37 including a shear associated with one of the first and second arms and positioned to cut the cable when the tension measured by the load cell exceeds a predetermined tension value.

39. The scraper assembly as claimed in claim 31 comprising a spring associated with each of the first and second arms biasing the scraping element toward the first level.

40. The scraper assembly as claimed in claim 31 comprising:
a first pin attached to the first arm between the first and second ends;
a second pin attached to the second arm between the first and second ends;
a first fixed guide track associated with the first arm receiving the first pin and providing a path for the first pin that allows the scraping element to move between the first and second levels;
a second fixed guide track associated with the second arm receiving the second pin and providing a path for the second pin that allows the scraping element to move between the first and second levels.

41. The scraper assembly as claimed in claim 40 comprising a first spring connected to the first arm and a second spring connected to the second arm to bias the scraping element toward the first level.

42. The scraper assembly as claimed in claim 40 wherein each of the first and second fixed guide tracks includes an outwardly convex track segment, a linear track segment, and an outwardly concave track segment, wherein each pair of segments meet at separate junctions to form a closed track circuit.

43. The scraper assembly as claimed in claim 31 wherein the scraping element is selected from the group consisting of a cable, a wire, a rod, a wiper, a blade, a roller with a raised helical surface, a roller with an abrasive surface, a paddle-wheel roller, an array of parallel cables, and an array of parallel rods.

44. A scraper assembly comprising:
first and second arms, each pivotable about a pivot axis over a pivot range and having a first end and a second end;
a linear scraping element connected between the second ends of the first and second arms;
wherein the linear scraping element is movable between a first level and a different second level as the first and second arms pivot over the pivot range.

45. The scraper assembly as claimed in claim 44 comprising a spring associated with each of the first and second arms biasing the linear scraping element toward the first level.

46. The scraper assembly as claimed in claim 45 wherein the springs are extension springs, leaf springs, or clock springs.

47. The scraper assembly as claimed in claim 44 comprising a third arm and a fourth arm and wherein:
the first arm includes a first pivot and the second arm includes second pivot defining the pivot axis with the first pivot;
the third arm is connected to the linear scraping element and to the first pivot to form a four-bar linkage with the linear scraping element and the first arm and the first pivot;
the fourth arm is connected to the linear scraping element and to the second pivot to form a four-bar linkage with the linear scraping element and the second arm and the second pivot.

48. The scraper assembly as claimed in claim 44 comprising:
a first pivot connected to the first arm and a second pivot connected to the second arm;
a first counterweight and a first counterweight arm connected at one end to the first pivot and at the other end to the first counterweight;
a second counterweight and a second counterweight arm connected at one end to the second pivot and at the other end to the second counterweight;
wherein the first and second counterweights bias the linear scraping element toward the first level.
